(19) United States
(12) Patent Application Publication
(10) Pub. No.: US 2009/0252163 A1
(43) Pub. Date: Oct. 8, 2009

(54) Grammar and Ontology for Multicast Communication

(75) Inventor: Pratik K. Biswas, Morganville, NJ (US)

Correspondence Address: TELCORDIA TECHNOLOGIES, INC., ONE TELCORDIA DRIVE 5G116, PISCATAWAY, NJ, 08854-4157, US

(73) Assignee: Telcordia Technologies, Inc., Piscataway, NJ (US)

(21) Appl. No.: 12/418,295

(22) Filed: Apr. 3, 2009

Related U.S. Application Data
(60) Provisional application No. 61/042,066, filed on Apr. 3, 2008.

(51) Int. Cl. H04L 12/56; G06F 9/44

(52) U.S. Cl. 370/390; 717/116

(57) ABSTRACT

A formal language for specifying and implementing multicast communication, named MSIL, comprises a set of constructs that are specific to multicast communication. The language provides semantic structures for repetitive, conditional, sequential, and parallel execution. It supports message passing, is extendible and domain independent. The language is flexible enough to be used for translating high-level multicasting requirements into abstractions, as well as implementing low-level systems supporting these requirements. MSIL can also be used as a command and communication language to control node behavior for multicast communication. The requirements, syntax and semantics of MSIL, together with the ontology for multicast communication are described. A selected set of high-level requirements, for multicast network management, is analyzed to determine the corresponding MSIL specifications. A simplified QoS Manager, capable of providing multicast QoS to a restricted wireless network, has been coded in MSIL to demonstrate its suitability for system development.

### CROSS-REFERENCE TO RELATED APPLICATIONS

This application claims the benefit of U.S. Provisional Application No. 61/042,066, filed on Apr. 3, 2008, which is incorporated by reference herein in its entirety.

### FIELD OF THE INVENTION

The present invention relates to multicast communications and specifically to a formal language that can specify and implement requirements, policies, instructions and abstractions for multicast transmission over communication networks.

### BACKGROUND OF THE INVENTION

Multicast is the delivery of the same information to multiple destinations simultaneously. Multicasting sends data from one host machine to many different clients but not to every client. The data goes to those clients that have expressed an interest in the data by joining a particular multicast group. Multicasting is a more efficient method of supporting group communication than unicasting or broadcasting, as it uses fewer communication connections and avoids needless duplication of data. Multicasting calls for a one-to-many communication model. Several important applications, e.g., conference meetings, discovery service, software updates, mobile commerce, electronic auction, military command and control, etc., use this model to transmit the same information to a group.

Multicasting over multiple heterogeneous networks is a challenging problem. These networks often comprise a wide variety of autonomous nodes that interact with each other over wired as well as wireless medium in a dynamic, uncertain, and real-time environment. The challenges are further compounded if the characteristics of the intermediate heterogeneous network segments are not observable from the originating or terminating network segments, as in cases of many military mobile ad hoc networks (MANETs). Mission-critical applications running in such environments often require continued connectivity, minimum loss and delay, atomic all or none transactions and reliable multicast.

Dynamic communication and control are essential for supporting multicast applications over such heterogeneous networks of autonomous devices. Multicast Specification and Implementation Language (MSIL) is a formal language that can capture the causal dynamical nature of these networks, vis-à-vis multicast communication, and provide seamless transformation from requirements to implementations through appropriate configurations.

There is much prior art on multicast communication, wireless multicasting and QoS. The dynamic throughput graph (DTG) based technique as described in A. Poylisher, F. Anjum, L. Kant, and R. Chadha, “QoS Mechanisms for Opaque Manets,” Proceedings of MILCOM, pp. 1-7, DC, Oct. 23-25, 2006 has been used for analyzing the current state of intermediate opaque networks (of wireless heterogeneous networks) and then using that knowledge to provide end-to-end QoS for both unicast and multicast flows, based on measurement-based admission control and quality adjustment. However, the present invention is not restricted to wireless multicasting or multicast QoS in general but to the application of a formal language for specifying and implementing multicast applications providing end-to-end QoS.

A number of languages, defining abstract communication primitives, have been proposed over the years for exchanging information and knowledge in distributed heterogeneous systems. Related recent work on formal specification for information processing can be grouped into three main categories: (1) object-oriented modeling and programming languages (2) agent communication languages, and (3) event-driven tactical command and control languages.

The Unified Modeling Language (UML) is a non-proprietary modeling language described in the book by M. Fowler and K. Scott, “UML Distilled Second Edition,” Addison-Wesley 2001 that can be used to design object-oriented (OO) systems. It is generally regarded as the complete specification of OO, as an abstract design expressed in UML can ideally be implemented in any OO programming language like C++, Java, Smalltalk, etc.

Agent-oriented programming as described in the article by Y. Shoham, “Agent-oriented Programming,” Journal of Artificial Intelligence 60 (1): 51-92, 1993 represents a software technology that has emerged from merging two technologies, namely, artificial intelligence (AI) and object-oriented distributed computing. The concept of a standard communication language for software agents, based on speech acts, has found wide appeal among both software researchers and developers. An agent communication language (ACL) must comprise a vocabulary, a content language, and an inter-lingua as described in the book by P. Wegner, “Coordination as Constrained Interaction,” Coordination Languages and Models, P. Giancarini and C. Hankin (Eds.), Springer LNCS 1061 (1996). Two of the most common ACLs are KQML and FIPA ACL described in Y. Labrou, T. Finin, and Y. Peng, “Agent Communication Languages: The Current Landscape,” IEEE Intelligent Systems, pp. 45-52, March/April 1999. The Knowledge Query and Manipulation Language (KQML) is described in Y. Labrou et al, supra, in H. Chalupsky, T. Finin, R. Fritzson, D. McKay, S. Shapiro, and G. Weiderhold, “An Overview of KQML: A Knowledge Query and Manipulation Language,” Technical report, KQML Advisory Group, April 1992. http://www.cs.umbc.edu/kqml/papers/kqmloverview.ps, in T. Finin, D. McKay, R. Fritzson, and R. McEntire, “The KQML Information and Knowledge Exchange Protocol,” Proceedings of 3^{rd} International Conference on Information and Knowledge Management (ICIKM), November 1994 and in Y. Labrou and T. Finin, “A Semantics Approach for KQML—A General Purpose Communication Language for Software Agents,” Proceedings of 3^{rd} ICIKM, November 1994 is a high-level message-oriented communication language and protocol for information exchange, independent of content syntax and domain ontology. The Foundation for Intelligent Physical Agents (FIPA) Agent Communication Language (ACL) in Y. Labrou et al supra, and Foundation for Intelligent Physical Agents, “FIPA Communicative Act Library Specification.” Standard Specification, Foundation for Intelligent Physical Agents, December 2002. http://www.fipa.org/specs/fipa00037/SC00037J.html is based on speech-act theory. FIPA ACL specification comprises a set of message types with a description of their pragmatics as well as a set of high-level interaction protocols. KQML and FIPA ACL are identical with respect to their basic concepts and principles but differ primarily in the details of their semantic frameworks. The asynchronous version of Knowledge-Level Agent Communication Language (KL-ACL) in M. Gaspari, “Concurrency and Knowledge-level Communication in Agent Languages,” Artificial Intelligence, Elsevier, vol. 105, pp. 1-45, 1998 has introduced concurrency aspects in the context of agent communication languages.

The event-based programming is based on the formal model for hierarchical discrete event control. It works by developing plant and controller automata and executing communication by using transducers between different controllers. The present invention considers the current research from device-oriented, event-driven languages such as A. Ray and S. Phoha, “A Language Measure for Discrete-Event Automata,” International Federation of Automatic Control (IFAC) World Congress '02, Barcelona, Spain, July 2002 and S. Phoha and M. Schmiedekamp, “C3L: An Integrated Computation, Communication and Control Language for Dynamically Controlled Heterogeneous Devices,” Proceedings of Intelligent Systems and Control, November 2007. The Common Control Language (CCL) was a direct predecessor of the Computation, Communication and Control Language (C3L) in S. Proha published in 2007, supra. These languages were originally developed mostly for the management of unmanned underwater vehicles (UUVs) and mobile robots. They were presented as tactical command and control languages for synthesizing mission scripts and controlling the behaviors of the autonomous devices. Agent-oriented middleware, as described in P. K. Biswas, S. Phoha, “A Middleware-driven Architecture for Information Dissemination in Distributed Sensor Networks,” Proceedings of ISSNIP, pp. 605-610, Melbourne, Australia, Dec. 14-17, 2004 and in P. K. Biswas, M. Schmiedekamp and S. Phoha, “An Agent-Oriented Information Processing Architecture for Sensor Network Applications,” International Journal of Ad Hoc and Ubiquitous Computing (IJAHUC), Inderscience, vol. 1, no. 3, pp. 110-125, 2006, have shown the applicability of both CCL and C3L for tracking targets and surveillance with sensor networks.

The proposed language of the present invention tries to integrate the agent-oriented approach with the event-based approach. MSIL is influenced by both ACLs as well as CCL and C3L. However, the syntax, programming constructs and semantics of MSIL are different from those of the aforesaid languages and are specific to multicast communication. Unlike event-based languages, MSIL is message-driven but the message types of MSIL are different from the performatives or speech-acts of ACLs. Unlike ACLs, MSIL doesn't provide a separation between the outer communication and inner content layers.

### SUMMARY OF THE INVENTION

The network model of the present invention comprises a mix of wireline and wireless networks. The properties of the wireline networks are significantly different from those of the wireless networks. Application flows originate from and terminate at the wireline networks, which constitute the end user network segments. The intervening networks are wireless in nature and opaque due to multiple levels of security restrictions. The only knowledge available of these networks is their wireless nature and technology used, e.g., TDMA, CSMA. From the technology it can be assumed that it will be possible to infer the maximum capacity.

In such a heterogeneous network, sources, receivers and significant routers for multicast flows will reside on the end user network segments. An ingress router is a router that connects the end network segment that originates a flow with the opaque network, while an egress router is one that connects the opaque network with a terminating end network segment, for the flow under consideration. The path between the ingress and the egress platforms can often change due to mobility and/or due to varying link characteristics. Furthermore, the network provides differentiated support for different types of traffic classes. In accordance with the present invention it is further assumed that the network will support Internet Group Management Protocol (IGMP) for group management and the Protocol Independent Sparse Mode (PIM-SM) for multicast routing. Multicast configuration management, for such a network, involves the static and dynamic creation of multicast groups and configuration of sources, receivers, routers and rendezvous points (RPs).

The network model uses a measure of throughput of the transmitted traffic from the end network and across the opaque network as the state descriptor of the opaque network. Throughput can be measured cheaply by counting, for every source/receiver (ingress manager/egress manager) pair in a group, the traffic (bytes) sent and received over a configurable time interval for every multicast flow and then determining the ratio of the two counts. This information can then be used to construct throughput graphs, termed as the dynamic throughput graphs (DTGs), that will be continuously updated according to the dynamics of the underlying network. End-to-end QoS assurance for multicast communication, comprising admission control and quality adjustment, are based on these throughput graphs.

It should be noted that MSIL is applicable to multicast communication over any heterogeneous wireless network. However, for simplicity sake the following description considers the above network model, as it demonstrates system development in MSIL for multicast QoS by partially implementing the throughput graph based solution, relevant only for this particular model.

The present invention will be more clearly understood when the following description is read in conjunction with the accompanying drawings.

### BRIEF DESCRIPTION OF THE DRAWINGS

FIG. 1 shows the syntax of Multicast Specification and Implementation Language (MSIL) in BNF.

FIG. 2 shows a sample ontology for multicast communication.

FIGS. 3(a)-3(g) show MSIL features.

FIG. 4 shows MSIL goal, policies, forward and permit lists

FIG. 5 is a semantic analysis of three MSIL commands.

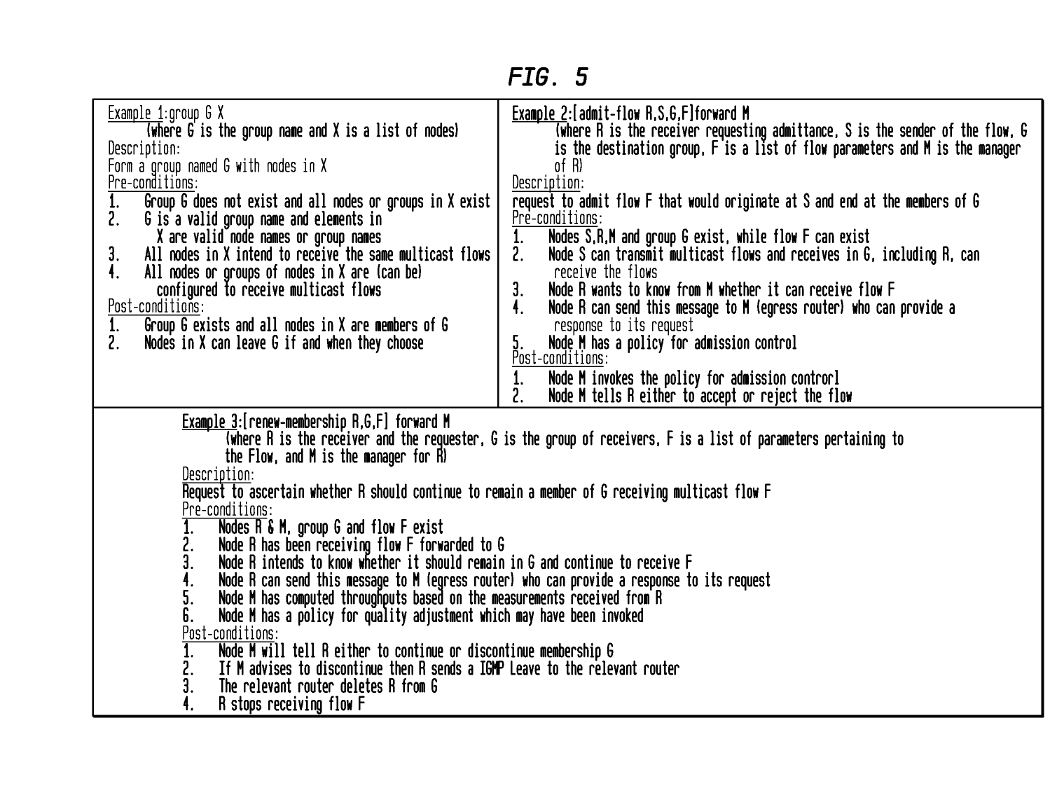

FIG. 6 is a conceptual design of a multicast QoS manager.

FIG. 7 shows the development of the multicast QoS manager.

### DETAILED DESCRIPTION

The heterogeneous wireless network can be modeled as a system of interacting automata, using discrete event representations for each node. Each autonomous node can be represented as a discrete event transducer and described by the following tuple:

AN=(S,I_{c},Iᵤ,O,G,δ,qₒ,F), (1)

where S is a possibly countably infinite set of states, I_{c} is the input alphabet consisting of the set of controllable events, Iᵤ is the input alphabet consisting of the set of uncontrollable events, O is the output alphabet, G is the set of groups this node is a member of, δ is a partial function in S×(I_{c}∪Iᵤ)→S×O denoting state transitions, qₒ is the start state and F is a set of significant states. Note that the set G is empty for unicast transmission. I=I_{c}∪Iᵤ, and I is called the input alphabet for the node. A controllable event is an event that triggers a predictable node behavior and can be enabled or disabled by the node. Uncontrollable events are events occurring of their own accord and can not be enabled or disabled by the node. Execution of every prominent node behavior takes the node to a state in F. The output alphabet for each node, O, consists of every literal that can be communicated in response to the triggering of events from its input alphabet, I. In general, each node operates like a transducer by: (1) receiving a command string, sᵢₙεI*, written in the input alphabet, from another node (as events in I_{c}) or from its own environment (as events in Iᵤ), (2) transitioning through a series of state transitions causing the output of literals from the output alphabet to generate the output string, sₒᵤₜεO*, and (3) communicating the response to members in G (groups) or to the sender of the command. The act of converting an input string to an output string in this manner is called a translation.

MSIL: Multicast Specification and Implementation Language

The Multicast Specification and Implementation Language (MSIL) has been designed to capture the causal dynamical architecture of autonomous nodes conducting multicast communication in complex, time-critical environments. It is a language that can be used for specifying abstractions and requirements for multicast communication, as well as for implementing systems that can support multicast applications by meeting these requirements.

A. Requirements

The key requirements of the language are summarized below in an axiomatic form.

Formality: MSIL incorporates the formal model of discrete event control.

Flexibility: MSIL can translate requirements as well as implement detailed systems.

Message Passing: MSIL supports message passing.

Expressiveness: MSIL provides semantic structures for repetitive, conditional, sequential, and parallel execution; nesting of general and personal policies and commands. It includes syntax for group constructs and permit & forward lists.

Extensibility: MSIL permits the addition of new constructs to accommodate new capabilities.

Fidelity: MSIL is complete enough to express a wealth of mission goals and node policies.

B. Grammar

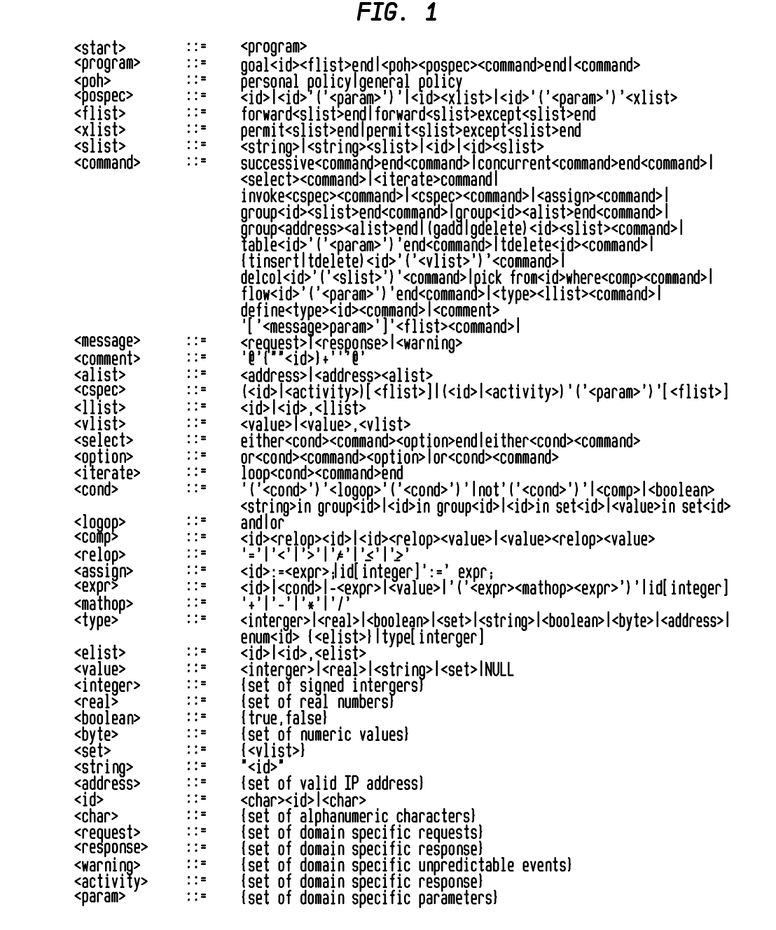

The syntax of MSIL is shown in FIG. 1 in BNF. A compiler or interpreter is required which compiles the language and converts it into machine readable form for execution on a computer.

C. Domain Ontology

Ontology adds meaning to symbolic literals in a language. It is critical that every autonomous node in the system agrees on a common set of terminologies.

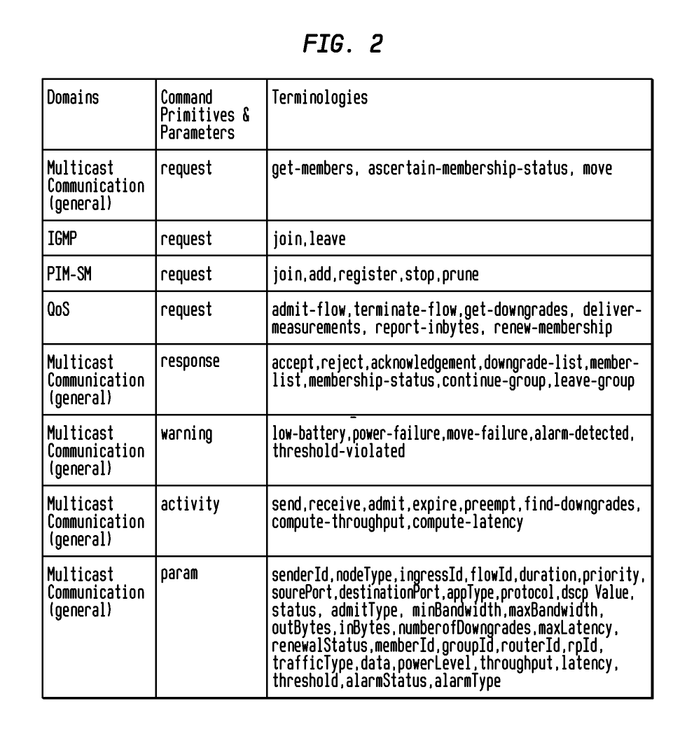

In the syntax of MSIL, <request>, <response>, <warning> <activity>, and <param> are undefined because MSIL allows system developers to define their own custom set of domain-specific commands and parameters. In this way, developers define the domain ontology for the application. A subset of the ontology for multicast communication, i.e., multicast configuration, transmission, routing and quality of service is shown in FIG. 2.

D. Features of MSIL

A MSIL program is a sequence of specifications. Each specification can employ one from the different programming constructs of MSIL. The following is a discussion on some its key features.

1) Multicast Data Types

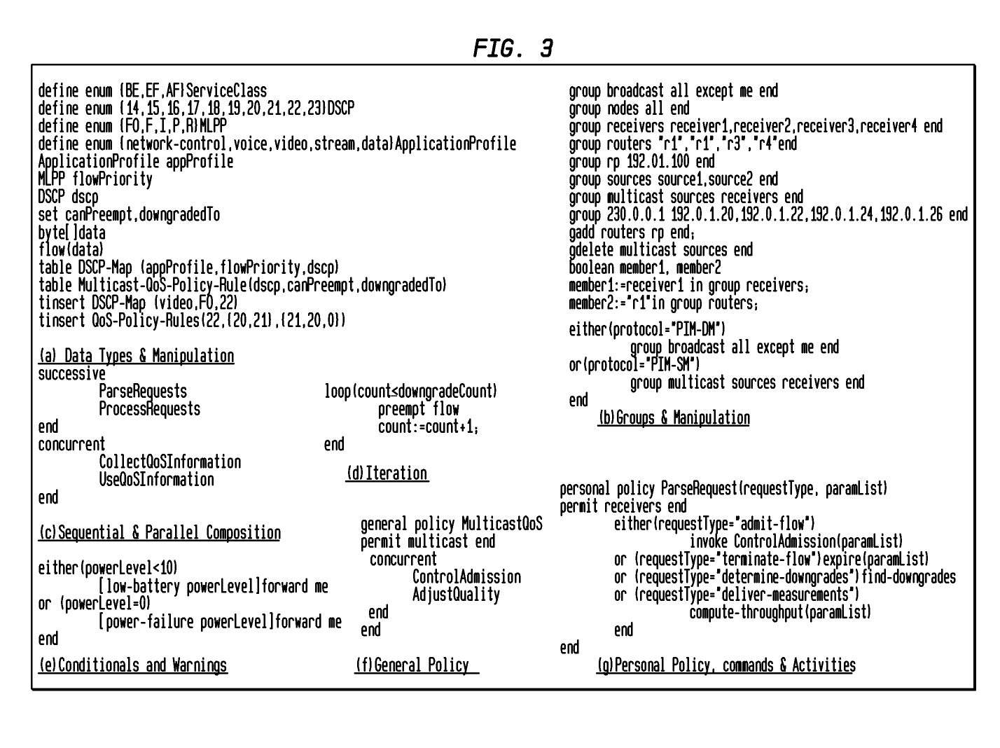

MSIL allows developers to define data types for Application Profile, Service Class, DSCP, Priority, etc., that are specific to multicast communication. It supports the enum and the set types for variables that can have one value from a fixed set of values as well as multiple values respectively. The table construct enables the multicast application developers to encode and manage DSCP mappings and preemption rules, consistent with a DiffServ/MLPP-based network. The flow construct allows the creation of multicast flows, with transmission data being encapsulated in bytes. FIG. 3(a) presents multicast data types and their manipulations.

2) Group Formation and Membership Management

Dynamic creation and modification of groups is central to providing dynamic organization of nodes for multicast communication. The group construct allows a list of nodes to be associated with and referred to by an id (identifier) or group name. Group structures can be modified in two ways, by using gadd and gdelete commands. The gadd and gdelete commands can be used to add or remove a node, a list of nodes or another group to or from a core multicast group. FIG. 3(b) illustrates group formation and membership management.

3) Sequential and Parallel Composition

MSIL provides for two different forms of composition: sequential and parallel. Parallel execution is denoted by a block of commands between concurrent and end. The commands within the block can be executed in any order but they must precede what follows the block. Sequential execution is denoted by a block of commands between successive and end. The commands in the block are executed sequentially in the order in which they appear in the block. These two types of commands can be nested to allow more complex interleaving of concurrent and sequential execution. If a series of requests occur without these keywords then they are treated as sequential. FIG. 3(c) shows constructs for successive and concurrent compositions.

4) Iteration

MSIL facilitates iterative execution using the loop construct. As long as the Boolean expression evaluates to true, the commands within the loop construct will execute as specified. Sequential and parallel segments can be included within the scope of the loop construct. FIG. 3(d) is an example of iteration.

5) Conditionals

MSIL facilitates conditional and selective execution using the either- or construct. The construct permits conditional execution based on satisfaction of specified preconditions. It allows a selection among a series of command lists, based on the value of boolean expressions. The initial condition and command(s) pair can be followed by additional pairs, each separated by a or. The following conditions are checked only if the preceding conditions are false. The block is terminated by an end delimiter. FIG. 3(e) demonstrates the use of conditionals.

6) Policies, Commands, Activities and Messages

MSIL allows developers to encapsulate private and public node behaviors into labeled modules called policies. A policy can be triggered inside a node in response to an input request or an internal warning (event/stimulus). A personal policy is a private behavior, unobservable by other nodes, and can be invoked only from within the local scope of the MSIL program in which it is located. A general policy is a public behavior, shared by others, and can be enabled by an external invocation. A policy may comprise of one or more commands. A command may create and manipulate data structures or groups, define types, declare variables, select a choice, iterate through a loop, invoke a policy, trigger an activity, provide a comment, issue a directive or a warning in a message exchange or may do some combination of these. It can be invoked using the invoke command, and may be forwarded to particular nodes using the forward list. Activities, warnings and message exchanges (request/response) are specific to the multicasting problem domain. FIG. 3(f) shows an example of a general policy, while FIG. 3(g) shows a personal policy consisting of commands and activities.

7) Permit and Forward Lists

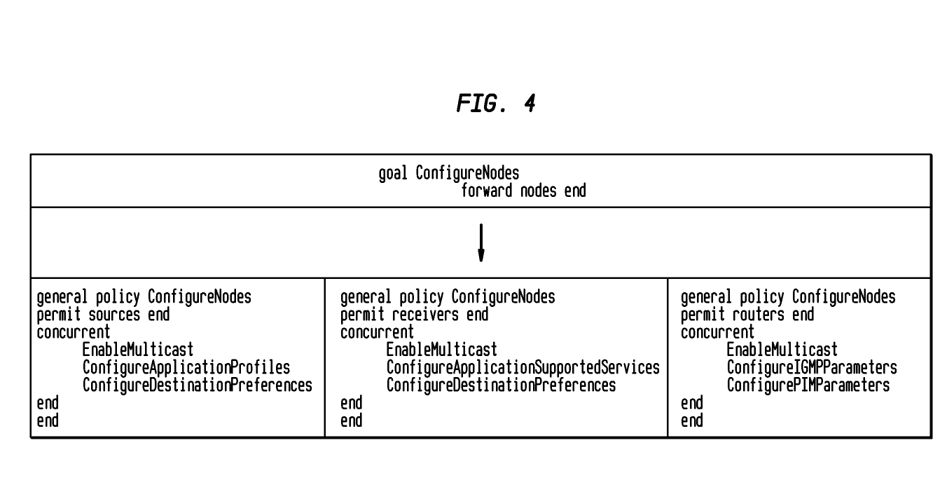

Usually general policies can be invoked by any node. However the designer can restrict this freedom and identity of which groups or individual nodes have authority to invoke certain policies using the permit-except list. Presence of the permit lists is optional and if not present, the default is to permit all nodes for a general policy and decline none. If at least one literal appears in a permit list, all other nodes are not allowed to invoke the policy. The forward lists work in the same way. The forward list can be used to direct the goals and commands to targeted recipients. FIG. 4 shows the use of forward and permit lists.

8) Multicast Goals and Policies

MSIL allows developers to define reusable goals for multicast communication. Goals are high-level policies or commands. At the top level, a goal is an abstraction of a multicast requirement that is ultimately implemented by the nodes or the network. As the goal gets communicated to the nodes, higher-order goals or commands are translated into more detailed lower-level policies. At the lowest levels, the policies get translated into activities that are performed by nodes in response to some messages. A higher-level goal may be translated one way for one node and another way for another node. This is often needed in systems where nodes have different functional capabilities. For multicast communication, sources, receivers and routers can often apply different functional capabilities for the same policy. FIG. 4 illustrates how the same high-level goal for node configuration gets translated into different low-level policies for sources, receivers and routers.

E. Semantics for MSIL Commands

The general semantic description of a MSIL command and message exchange in particular, can be expressed in terms of the following constituents:
1. A natural language description of the command's (directive's) intuitive meaning.
2. Pre-conditions that indicate the necessary states of the network and nodes prior to the execution of the command (states of sender and receivers before a message has been exchanged between the nodes).
3. Post-conditions that describe the states of the network and the nodes after the execution of the command (states of the nodes after a message has been sent and received)

F. MSIL and Formal Model

Each considered node in the end user segment of the heterogeneous network is a transducer having the form given in equation (1) and is modeled as a discrete event system with a set of states S with an initial state qₒ, an input alphabet I consisting of all incoming messages, i.e., incoming requests and warnings, an output alphabet O consisting of all its responses and outgoing requests, a set of multicast groups G that it is a member of, and a set of states F representing the completion of significant policies, commands and activities related to multicast communication. The intermediate network segments are not considered here as they are opaque.

A node receives requests from other nodes and warnings from its private event handler for unpredictable events, triggering its policies, commands and activities. Incoming messages, consisting of requests and warnings, therefore, are in the form of input strings in MSIL and the set of all possible strings that the node can respond to is its input language, Lᵢₙ=I*. The output language, Lₒᵤₜ=O*, for a node is the set of output MSIL strings that the node can produce. Nodes can respond to incoming requests, or issue requests to other nodes. The node's translation function T(AN) is defined by the mapping from input to output languages, i.e., T(AN)=Lᵢₙ→Lₒᵤₜ.

Definition 1: Two or More Autonomous Nodes (ANs) in the End-Segment are Said to be Equivalent if they Employ the Same Translation Function T(AN).

Modeling Requirements in MSIL for Multicast Communication

This following description illustrates the applicability of MSIL in modeling high-level requirements for multicast communication. MSIL constructs can be used in translating requirements into relevant specifications that can be transformed later into complete MSIL programs during the system development phase.

E. Multicast Requirements

A generic set of requirements for multicast communication is considered here to corroborate the modeling capabilities of MSIL. The requirements cover multiple domains from network management systems (NMS), including configuration management, routing, fault management, performance management and quality of service (QoS). The following is an enumeration of these requirements, together with the corresponding MSIL translation for each requirement.

[Req-1]: NMS Shall Support Multicast Traffic Types, DiffServ-Based Service Classes and MLPP Based Priorities.

MSIL Translation: MSIL syntax supports the enum data type. MSIL developers can use this basic type to define their own data types for Application Profile, Service Class, DSCP, Priority, etc., that are specific to multicast communication. FIG. 3(a) illustrates the use of multicast data types.

[Req-2]: NMS Shall Support Creation of Static and Dynamic Multicast Groups and Provide API to Add and Delete Multicast Groups.

MSIL Translation: The MSIL syntax provides for the group construct. Groups can be defined statically through high-level commands during the planning phase or created dynamically through a select command (conditional) during program execution. The commands gadd and gdelete can be used to dynamically modify a group. FIG. 3(b) shows the creation (static and dynamic) and modification of the group constructs in MSIL.

[Req.-3]: NMS Shall Assign User Defined Names to Multicast Groups to Enable Applications to Query and Retrieve Addresses or Identifiers of Multicast Groups.

MSIL Translation: The MSIL group construct allows a list of nodes to be associated with and referred to by a user-defined id (identifier), address or group name. Nodes can query routers for a list of group members and membership-status in a group by sending the get-members and ascertain-membership-status messages. A router can use the in operator to check for a node membership in a group. FIG. 3(b) provides examples.

[Req-4]: NMS Shall Support Internet Group Management Protocol (IGMP).

MSIL Translation: MSIL ontology (FIG. 2) includes join and leave as valid request types. Nodes wanting to join or leave a multicast group can send a join or leave message, as a MSIL command, to the corresponding router.

[Req-5]: NMS Shall Support Protocol Independent Protocol-Sparse Mode (PIM-SM), PIM-Dense Mode (PIM-DM) Routing Protocols.

MSIL Translation: MSIL syntax allows for the creation of multicast and broadcast groups. Multicast transmission can be accomplished through the send and receive activities. MSIL ontology (FIG. 2) includes join, add, register, stop, prune as valid request types. Routers can send messages to the rendezvous point (RP) with these requests.

[Req-6]: NMS Shall Perform Configuration Management that Supports Configuration of Nodes for Multicast Transmission.

MSIL Translation: A high-level goal can be defined in MSIL for configuration management of nodes for multicast communication. The goal can be forwarded to different multicast groups, i.e., sources, receivers and routers. Each group can have its own general policy for configuration management. The high-level goal would thus get translated into an appropriate policy for node configuration for multicast communication, depending on the group to which the node belongs. FIG. 4 shows an example.

[Req-7]: NMS Shall Configure the Routers with the Protocol Parameters Such for PIM-SM, as Well as Assign and Configure Rendezvous Points (RPs).

MSIL Translation: A general policy can be defined to configure the routers for PIM-SM protocol implementation. The policy can invoke personal policies (commands) to enable multicast parameters, IGMP parameters and PIM-SM parameters. Likewise, a personal policy can also be defined to configure the rendezvous point (RP) for PIM-SM routing protocol. The policy can assign the groupID and the rpID parameters to the multicast group address and the address of the rendezvous point router. FIG. 4 provides an example of such a policy.

[Req-8]: NMS Shall Support Dynamic Configuration for Multicast Traffic.

MSIL Translation: MSIL allows developers to dynamically define data types for Application Profile, Service Class, DSCP, Priority, etc., specific to multicast traffic, as commands during program execution. The table construct further enables the multicast application developers to dynamically encode and manage DSCP mappings and preemption rules, consistent with a DiffServ/MLPP-based network. These maps and rules can be used and manipulated, from within personal policies, to dynamically configure multicast traffic during flow preemption.

[Req-9]: NMS Shall Collect and Log Alarms from Multicasting Nodes.

MSIL Translation: MSIL syntax provides warnings to indicate the occurrence of unpredictable events. MSIL ontology includes primitives for alarm detection, low battery, power failure, threshold violation, movement failure, etc. These warnings invoke appropriate policies or commands for remedial activities. FIG. 3(e) shows the usage of warnings.

[Req-10]: NMS Shall Periodically Gather Performance Data for Multicast Traffic at Egress of the Interface Network Element, Compute Throughputs and Latencies, and Also Monitor Performance Threshold Violations.

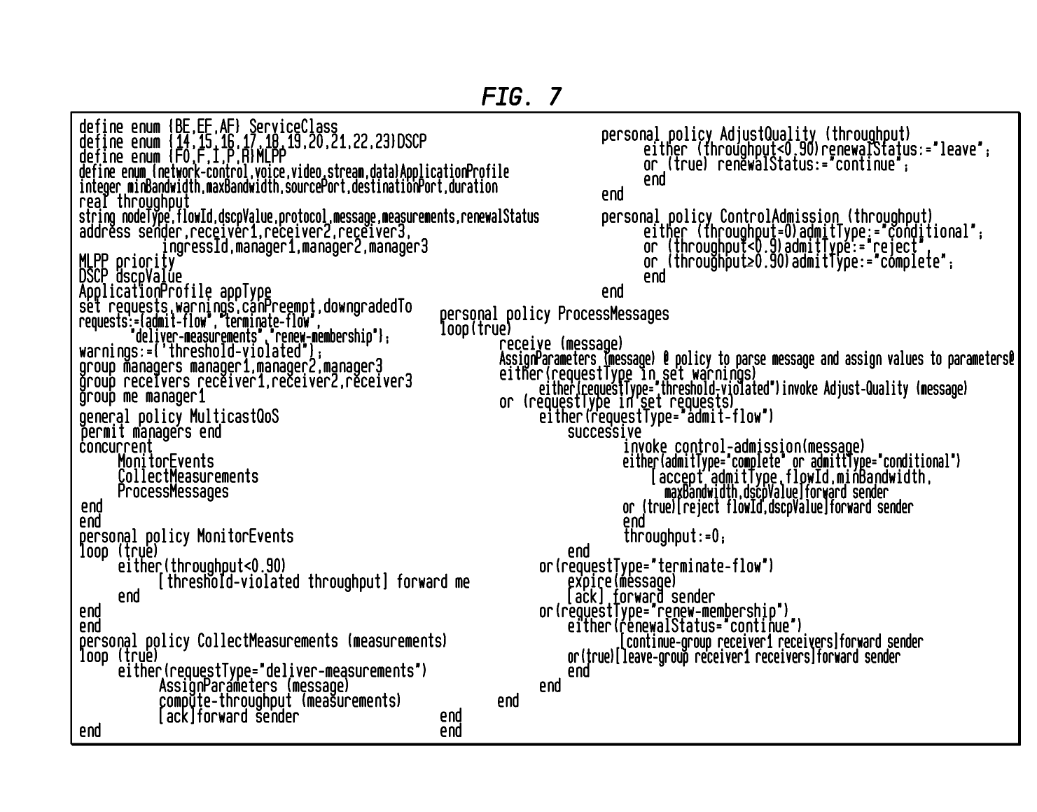

MSIL Translation: A personal policy can be defined for the group receivers (egress routers) that would consist of activities to calculate throughputs (compute-throughput) and latencies (compute-latency) and monitor threshold violations. MSIL syntax includes warning to indicate threshold violations (threshold-violated). FIG. 7 includes such a policy.

[Req-11]: NMS Will Support Concurrent Collection and Usage of QoS-Related Measurements.

MSIL Translation: MSIL provides syntax for parallel composition. The concurrent end block can be used to execute commands, for collection and usage, in parallel. FIG. 3(c) provides an example of concurrent invocation of the two policies executing these tasks.

[Req-12]: NMS Shall Control Admission and Adjust Quality for Multicast Traffic.

MSIL Translation: Two personal policies can be defined for admission control and quality adjustment to provide QoS for multicast traffic. Only the multicast group consisting of managers would be permitted to execute the policy. The policies could be executed only from inside of the nodes. The two policies would run concurrently and make decisions by computing throughputs and monitoring threshold violations (warnings). FIG. 7 shows such policies.

Let R be the set of above-listed requirements, i.e., R={Req-n: where n is an integer, 1≦n≦12}. An important conclusion is presented below, based on the analysis of the requirements in R.

Proposition 1: The Grammar and Ontology of MSIL are Adequate for Specifying the Requirements in R.

Proof: The analysis, in Section VI A, has shown that for every requirement in R, there are corresponding types, operations, programming constructs, message types, activities, parameters and terminologies in MSIL. Hence, it can be concluded that the syntax and ontology of MSIL can adequately translate the requirements in R.

System Development in MSIL for Multicast QoS

MSIL can be used in developing complete systems for multicast communication over heterogeneous wireless networks. A subset of these wireless heterogeneous networks, whose network model has been discussed above, is considered here for system development.

This solution applies PIM-SM as the routing protocol, source-based multicast trees (RP at source), and unirate transmission for multicast QoS. Source and receivers have associated QoS managers. The managers can be hosted either on the nodes themselves or on the ingress/egress routers or can exist on their own. All QoS related decisions are executed by the QoS managers. The QoS managers, for both source and receivers, can execute the policies for admission control and quality adjustment. Managers for the receivers receive measurements from the receivers and the manager for the source. The QoS manager for each receiver creates and maintains its DTG. The QoS policies ensure that a receiver either receives all or none.

The control admission policy (admission control) conditionally admits a flow in the network between any pair of source and receiver in a multicast group if there is no other flow between them. This implies that the DTG is not computed by the time the request for admission for the flow is received. Once the flow starts and DTG is computed, the policy can use it to make its decisions. The flow is completely (unconditionally) accepted if the throughput is above or equal to a predefined threshold and rejected otherwise. The QoS manager for the receiver continuously monitors its throughput, re-computes it after each receipt of measurements (ingress and egress byte counts) and raises a warning if the throughput falls below the threshold. The adjust quality policy (quality adjustment) is then invoked to ensure that the corresponding receiver leaves the multicast group when the next periodic request is received for group membership renewal.

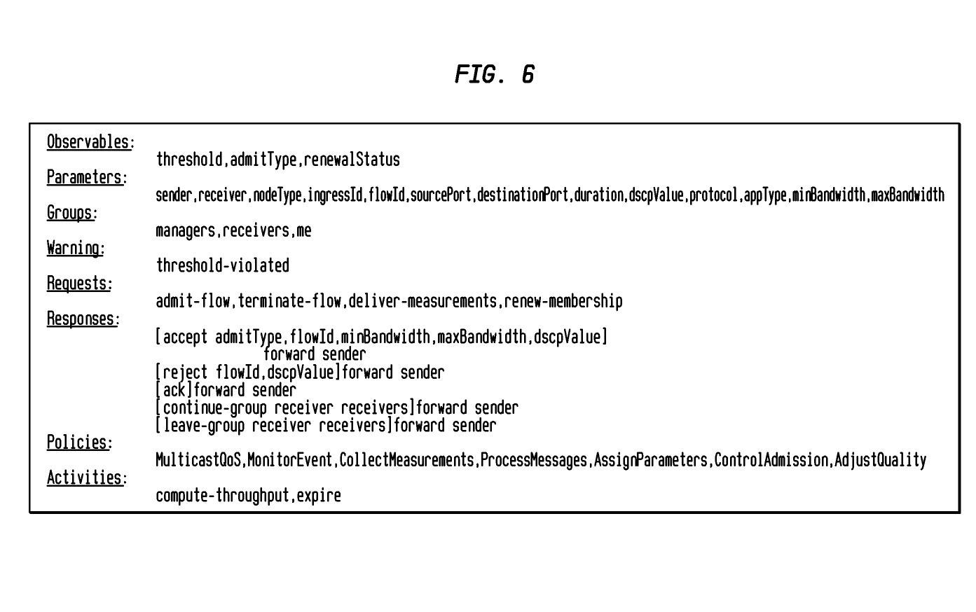

A simplified QoS manager, for a receiver node, is implemented next in MSIL. FIG. 6 shows the outputs from the design phase and FIG. 7 shows the MSIL code that can implement the QoS manager, based on this design. A list of observables, parameters, groups, warning, requests, responses, policies and activities are identified in the design phase, which are subsequently implemented in the development phase to reflect the behavior of this QoS manager.

It can be observed from FIG. 6 and FIG. 7, that for any QoS manager, Lᵢₙ={threshold-violated, admit-flow, terminate-flow, deliver-measurements, renew-membership} and Lₒᵤₜ={accept, reject, ack continue-group, leave-group}. The following two important conclusions can be inferred for the aforesaid QoS solution, based on the above input and output languages and Definition 1.

Proposition 2: Each Multicast Group with More than One Member Consists of Equivalent Nodes.

Proof: The proposed QoS solution uses three multicast groups, i.e., managers, receivers and me. Two of these groups, i.e., managers and receivers comprise more than one member. Each multicast functional group encapsulates similar policies, commands and activities. All receivers can receive multicast flows and generate outgoing requests for their corresponding managers from the same output language (incoming requests to corresponding managers). All managers can receive self-generated warnings and incoming requests from the same input language Lᵢₙ and generate outgoing responses from the same output language Lₒᵤₜ. They can issue similar warnings for the same observable and produce identical responses for the same requests from their corresponding receivers. This implies that members of each multicast group have the same T(AN)=Lᵢₙ→Lₒᵤₜ. So they are equivalent (Definition 1).

Proposition 3: Two or More Nodes can Receive Multicast Transmission if their Corresponding QoS Managers Generate Identical Responses from their Output Languages (L_{Out}) for the Same Requests from their Input Languages (Lᵢₙ).

Proof: For the occurrence and continuity of multicast transmission involving two or more receivers, the corresponding QoS managers must accept the flow, not raise any warning (threshold-violated) and periodically ensure that their receivers continue to remain in (and not leave) the same multicast group (receivers) to receive the flow. This implies that the two or more nodes can continue to receive multicast transmission if their corresponding QoS managers produce identical responses from their Lₒᵤₜ, i.e., accept, ack and continue-group, to the same three request types, i.e., admit-flow, deliver-measurements and renew-membership from their Lᵢₙ. Now, this is indeed possible as all QoS managers are equivalent nodes (Proposition 2). As they have the same translation function, i.e., T(AN)=Lᵢₙ→Lₒᵤₜ, they can produce the same output strings for the same input strings.

In summary, a formal language has been described and illustrated for specifying and implementing multicast communication. The language, named MSIL, comprises a set of constructs that are specific to multicast communication. The language provides semantic structures for repetitive, conditional, sequential, and parallel execution. It supports message passing, is extendible and domain independent. MSIL is flexible enough to be used for translating high-level multicasting requirements into abstractions, as well as implementing low-level systems supporting these requirements. MSIL can also be used as a command and communication language to control node behavior for multicast communication. A formal model of MSIL has been described and illustrated. The requirements, syntax and semantics of MSIL, together with the ontology for multicast communication have also been provided. A selected set of high-level requirements, for multicast network management, has been analyzed to determine the corresponding MSIL specifications. A simplified QoS Manager, capable of providing multicast QoS to a restricted wireless network, has been coded in MSIL to demonstrate its suitability for system development.

The expressiveness of the language can be enhanced further by augmenting it with other programming constructs. Protocols like PIM-SM, PIM-DM and IGMP can be implemented using MSIL. MSIL can also be applied to develop systems for other solutions to multicast QoS over other types of wireless networks. Challenges remain in extending MSIL to cover other multicast routing protocols and mobility management for multicast communication.

Various aspects of the present disclosure may be embodied as a program, software, or computer instructions embodied in a computer or machine usable or readable medium, which causes the computer or machine to perform the steps of the method when executed on the computer, processor, and/or machine.

Systems and methods of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

While there has been described and illustrated a formal language for multicast communication, it will be apparent to those skilled in the art that variations and modifications are possible without deviating from the broad teachings and scope of the present invention which shall be limited solely by the scope of the claims appended hereto.

What is claimed is:

1. A formal language for multicast communication in a communication network having a plurality of autonomous nodes, comprising:
constructs that are specific to multicast communication;
semantic structures for repetitive, conditional, sequential, and parallel execution supporting message passing which is extendible and domain independent; and
an ontology for multicast communication.

2. A formal language for multicast communication in a communication network having a plurality of autonomous nodes as set forth in claim 1, further comprising:
requirements;
syntax as expressed through BNF grammar;
semantics as expressed through intuitive meanings, pre and post conditions of the language constructs; and
a formal model.

3. A formal language for multicast communication in a communication network having a plurality of autonomous nodes as set forth in claim 1, further comprising flexibility for implementing low-level systems.

4. A formal language for multicast communication in a communication network having a plurality of autonomous nodes as set forth in claim 1, wherein said language is used as a command and communication language to control node behavior for multicast communication.

5. A formal language for multicast communication in a communication network having a plurality of autonomous nodes as set forth in claim 1, wherein each autonomous node is represented by a discrete event transducer described by the following tuple:
AN=(S,I_{c},Iᵤ,O,G,δ,qₒ,F),
where S is a possibly countably infinite set of states, I_{c} is the input alphabet consisting of the set of controllable events, Iᵤ is the input alphabet consisting of the set of uncontrollable events, O is the output alphabet, G is the set of groups this node is a member of, δ is a partial function in S×(I_{c}∪Iᵤ)→S×O denoting state transitions, qₒ is the start state and F is a set of significant states.

6. A QoS manager for a receiver node for multicast communication in a communication network comprising:
a list of observables, parameters, groups, warning, requests, responses, policies and activities in a design phase; and,
an input language for the node Lᵢₙ={threshold-violated, admit-flow, terminate-flow, deliver-measurements, renew-membership} and an output language for the node Lₒᵤₜ{accept, reject, ack, continue-group, leave-group}
ensuring that each multicast group with more than one member comprises equivalent nodes and two or more nodes can receive multicast transmission if their corresponding QoS managers generate identical responses from their output language (Lₒᵤₜ) for the same requests from their input languages (Lᵢₙ).

7. A computer readable medium having a computer readable program for operating a QoS manager on a computer for multicast communication in a communication network the computer to perform the steps of:
providing a list of observables, parameters, groups, warning, requests, responses, policies and activities in a design phase; and,
providing an input language for the node Lᵢₙ and providing an output language for the node Lₒᵤₜ.

8. A computer readable medium having a computer readable program for operating a QoS manager on a computer for multicast communication in a communication network the computer to perform the steps as set forth in claim 7, wherein the input language for the node is Lᵢₙ={threshold-violated, admit-flow, terminate-flow, deliver-measurements, renew-membership} and output language for the node Lₒᵤₜ={accept, reject, ack, continue-group, leave-group}.

9. A computer readable medium having a computer readable language for operating on a computer for multicast communication in a communication network the computer to perform the steps of:
providing constructs that are specific to multicast communication;
providing semantic structures for repetitive, conditional, sequential, and parallel execution supporting message passing which is extendible and domain independent; and
providing an ontology for multicast communication.
